(19) United States
(12) Patent Application Publication
(10) Pub. No.: US 2003/0052924 A1
(43) Pub. Date: Mar. 20, 2003

(54) User interface with simultaneous display of menu tree levels

(76) Inventors: Gary David Carlson, Aliso Viejo, CA (US); Timothy Dean Elmore, Cypress, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 09/956,339

(22) Filed: Sep. 18, 2001

(51) Int. Cl. G09G 5/00

(52) U.S. Cl. 345/810

(57) ABSTRACT

A switching system that incorporates a user interface allowing the operator to see all levels of a multi-level menu simultaneously is disclosed. In particular, the user interface includes a rotary knob, an alphanumeric display and one or more keypad switches or push-buttons. The alphanumeric display of the system includes one or more lines arranged one above the other, thereby allowing all levels of a menu to be simultaneously visible. In addition, the keypad switches are arranged so that each switch is associated with one line of the display.

### BACKGROUND OF THE INVENTION

Automated test equipment systems (ATE) play a significant role in the manufacture of many products, such as pacemakers, jet engines, semiconductors and numerous other products covering a wide range of markets. ATE systems not only expedite product testing, but also improve product quality by conducting accurate and repeatable test processes with minimal user intervention.

At the heart of many automatic test equipment systems is switching. The main purpose of switching is to increase system throughput by switching source and/or measuring devices to multiple test points or Units Under Test (UUT). With a switching system, test equipment such as digital multimeters (DMM), signal generators, arbitrary waveform generators and other sophisticated instruments are shared within the test program. This test configuration not only eliminates the need for dedicated redundant instruments, but also reduces overall system costs by optimizing instrument use within the test system.

Switching systems generally include a chassis that contains two or more slots for switching cards. Each switching card includes a quantity of relays that can be independently opened or closed to control connections to an outside device. Testing modes or functions controlled by the switching system are presented in a hierarchical menu format and configured via a user interface that generally includes a display panel and several switches or navigation keys. The navigation keys are used to display the menu items and options, and set parameter values.

Conventional hierarchical menu formats or structures are generally analogous to traditional filing cabinets. A file cabinet contains several drawers. Each drawer is labeled with the general topic of its contents and contains a number of folders. Each folder is labeled with a subtopic that is appropriate or related to the general topic of the drawer. In addition, each folder holds individual documents that contain information pertaining to the subtopic of the folder. Thus, the information is stored in a hierarchical form. To find the desired information, a person first selects the cabinet drawer whose topic matches or relates to the desired information. Next, the folder within that drawer displaying the desired subtopic is then selected. Finally, the desired information or document is found within the selected folder.

In the field of electronic instrumentation, including switching systems, equipment has traditionally used a hierarchical menu system that is organized in a manner similar to that of a file cabinet, as previously described. At the top level of the hierarchical menu system, a user selects the general type of function to perform. Next, the user then selects a more specific class of functions contained within the general type. The user proceeds through succeeding lower levels until reaching the desired function.

Examples of switching systems using this type of conventional hierarchical menu format include the Keithley 2750 Multimeter/Switch system and the Agilent 3470 Data Acquisition/Switch Unit. In general, the Keithley system includes a display and several navigation and function keys. An example of an operation or procedure utilizing the hierarchical menu of the Keithley system is as follows.

To close a relay channel on a switch plug-in card, the user must first press the CLOSE key, followed by the ENTER key. Next the user must select the desired switch plug-in card. The Keithley Model 2750 display shows a three-digit number. The first digit represents the number of the selected switch plug-in module. The second and third digits represent the number of the selected relay. The number of the desired switch plug-in (first digit of the display) is set by using the LEFT, RIGHT, UP, and DOWN keys (designated by arrows pointing left, right, up, and down, respectively). Then, the number of the desired relay channel (second and third digits of the display) must be set by using the LEFT, RIGHT, UP, and DOWN keys. After selecting the switch plug-in card and channel number as described above, the user must press the ENTER key to close the relay channel.

To configure additional plug-in cards, the user must sequentially back through each of the previous menu levels, select the next desired plug-in card and repeat the numerous steps of the above described procedure.

The operating procedure for the Agilent system, though not exactly the same as that of the Keithley system, also includes a similar hierarchical menu structure. Further, and most importantly, both the Keithley and Agilent systems (and other conventional switching systems) include a limited user interface whereby only one level or a small portion of the hierarchical menu is displayed during each step of the operating procedure. As such, these conventional switching systems have cumbersome menu structures and are difficult and confusing to operate.

In view of the above, there is a need for switching system having a user-friendly interface and simplified method of use. In particular, it is desirable that the user interface allows an operator of the device to visibly see all levels of a multi-level menu simultaneously. In addition, the system should allow the operator to instantly skip to any level of the menu. Overall, the method of using such a system should be simple and straightforward.

### BRIEF SUMMARY OF THE INVENTION

In general, the present invention contemplates a system comprising a multilevel menu interface having one or more menus. Each menu of the system includes one or more levels with selectable parameters at each level. In addition, all selected parameters at each menu level are simultaneously, visibly displayed. The system may further include a display having one or more alphanumeric lines, a keypad having one or more push-buttons and/or a rotary knob that controls selection of the parameters.

The present invention also contemplates a method of using a multi-level menu interface of a switching system. The method includes activating the system so that a first menu having one or more levels is presented on a display of the system, whereby each level is presented on a separate line of the display. The method also includes depressing a first push-button on a keypad of the system to select a first level, wherein the first push-button corresponds to a first line on the display, and incrementally rotating a rotary knob, whereby an incremental rotation causes a second menu to be displayed. The method further includes depressing a second push-button on the keypad to select a second level on the second menu, incrementally rotating the rotary knob to select a parameter of the second level, depressing a third push-button on the keypad to select a third level on the second menu, incrementally rotating the rotary knob to select a parameter of the third level, depressing a fourth push-button on the keypad to select a fourth level on the second menu, and incrementally rotating the rotary knob to select a parameter of the fourth level.

An alternate method of using a multi-level menu interface of a switching system is also contemplated herein. The alternate method includes activating the system so that a first menu having one or more levels is presented on a display of the system, wherein each of the levels is presented on a separate line of the display. The method also includes depressing a first push-button on a keypad of the system to select a first level, wherein the first push-button corresponds to a first line on the display, and depressing the first push-button one or more times to cause a different menu to be displayed each time the key is pressed. The method further includes selecting a second menu, depressing a second push-button on the keypad to select a second level on the second menu, depressing the second push-button one or more times to select a parameter of the second level, depressing a third push-button on the keypad to select a third level on the second menu, depressing the third push-button one or more times to select a parameter of the third level, depressing a fourth push-button on the keypad to select a fourth level on the second menu and depressing the fourth push-button one or more times to select a parameter of the fourth level.

### BRIEF DESCRIPTION OF THE DRAWINGS

Other features and advantages of the present invention will be seen as the following description of particular embodiments progresses in conjunction with the drawings, in which:

FIG. 1A is a front, perspective view of one embodiment of the switching system and user interface in accordance with the present invention;

FIG. 1B is a back, perspective view of the system of FIG. 1A;

FIG. 2 illustrates one embodiment of the user interface in accordance with the present invention;

FIG. 3 is a flow chart illustrating one embodiment of a hierarchical menu structure in accordance with the present invention;

FIG. 4 illustrates another embodiment of the user interface in accordance with the present invention;

FIG. 5 illustrates another embodiment of the user interface in accordance with the present invention;

FIG. 6 illustrates another embodiment of the user interface in accordance with the present invention;

FIG. 7 illustrates another embodiment of the user interface in accordance with the present invention;

FIG. 8 illustrates another embodiment of the user interface in accordance with the present invention;

FIG. 9 illustrates another embodiment of the user interface in accordance with the present invention;

FIG. 10 illustrates another embodiment of the user interface in accordance with the present invention;

FIG. 11 illustrates another embodiment of the user interface in accordance with the present invention;

FIG. 12 illustrates another embodiment of the user interface in accordance with the present invention;

FIG. 13 illustrates another embodiment of the user interface in accordance with the present invention;

FIG. 14 illustrates another embodiment of the user interface in accordance with the present invention;

FIG. 15 illustrates another embodiment of the user interface in accordance with the present invention;

FIG. 16 illustrates another embodiment of the user interface in accordance with the present invention; and

FIG. 17 illustrates another embodiment of the user interface in accordance with the present invention.

### DETAILED DESCRIPTION OF THE INVENTION

Disclosed herein is a detailed description of various illustrated embodiments of the invention. This description is not to be taken in a limiting sense, but is made merely for the purpose of illustrating the general principles of the invention. The section titles and overall organization of the present detailed description are for the purpose of convenience only and are not intended to limit the present invention.

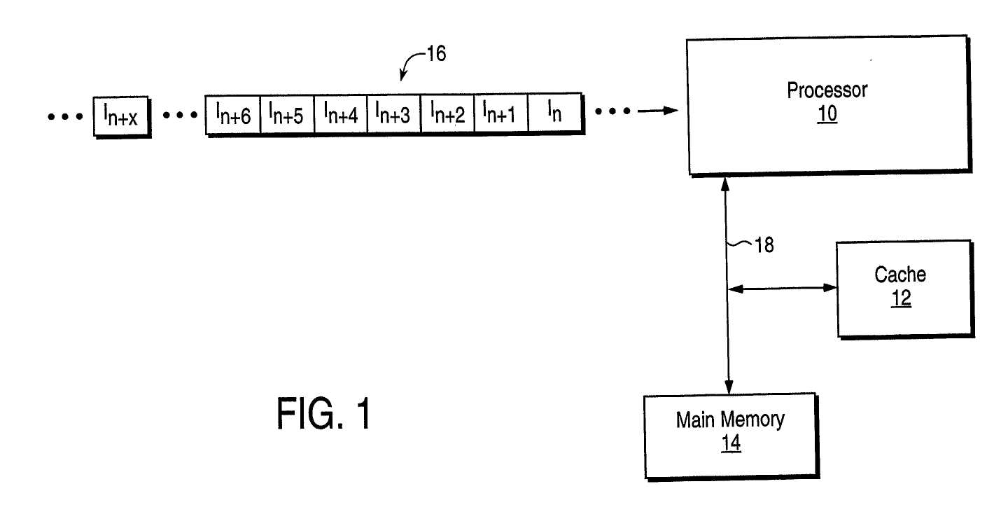

FIGS. 1A and 1B show a preferred embodiment of an automated test equipment (ATE) switching system 10 having a multi-level menu interface. In general, the rack-mountable switching system 10 includes a chassis 12 having a front 14, back 16, two sides 18, 20, a top 22 and a bottom 24. As shown in FIG. 1B, the back 16 of the chassis 12 includes, but is not limited to, one or more slots 26 for a variety of plug-in switching cards (or plug-ins or modules) 28, an RS-232 remote interface 30 for interconnection of test equipment with computers, a GPIB (General Purpose Interface Bus) 32 and a power module 34. The plug-in switching cards 28 provide the switching system 10 with a wide range of switching capabilities, such as, for example, high current to 13 Amps, high voltage to 1 kV, RF/microwave to 13 GHz, and digital I/O with 96 channels per plug-in. These particular device settings illustrate one example of the capabilities of the switching system 10 of the present invention. Other device configurations and capabilities not specifically disclosed herein but well known by those skilled in the art are also included within the scope of the present invention.

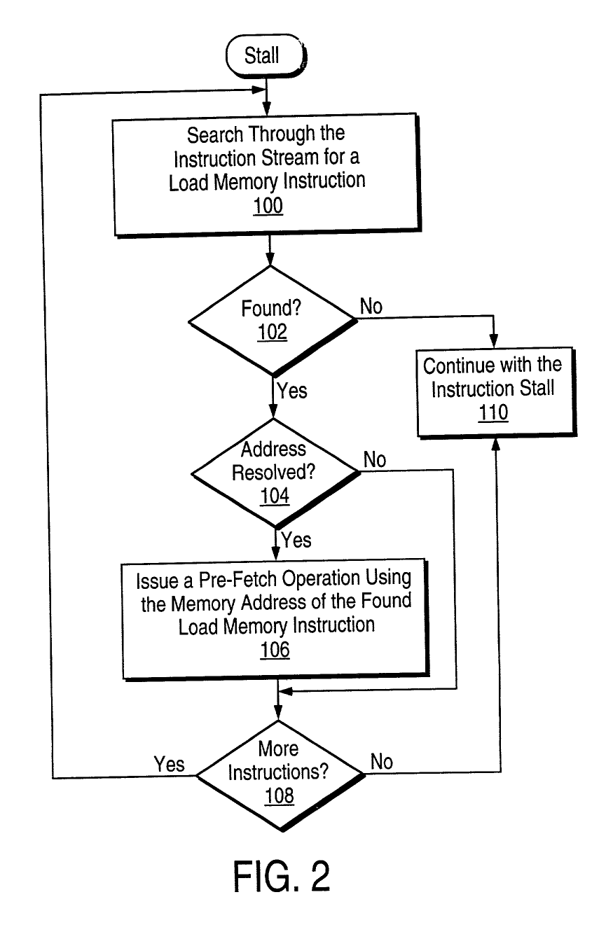

Referring to FIG. 1A, an intuitive menu-driven interface or control panel 36 located at the front 14 of the chassis 12 of the switching system 10 includes, but is not limited to, a display 38, a keypad 40, a speaker 42 and a control knob 44. The keypad 40, generally located adjacent the display 38, includes one or more push-button(s), soft-key(s), lever(s), switch(es), touchpad(s) or other similar components 46. In one embodiment of the present invention, shown in FIG. 2, the display 38 is a vacuum fluorescent display including four alphanumeric lines 48 per screen 50 with twenty-characters 52 per line 48. However, other display configurations, such as liquid crystal displays (LCD), plasma displays, or displays having one or more lines with one or more characters or icons per line, are also included within the scope of the present invention.

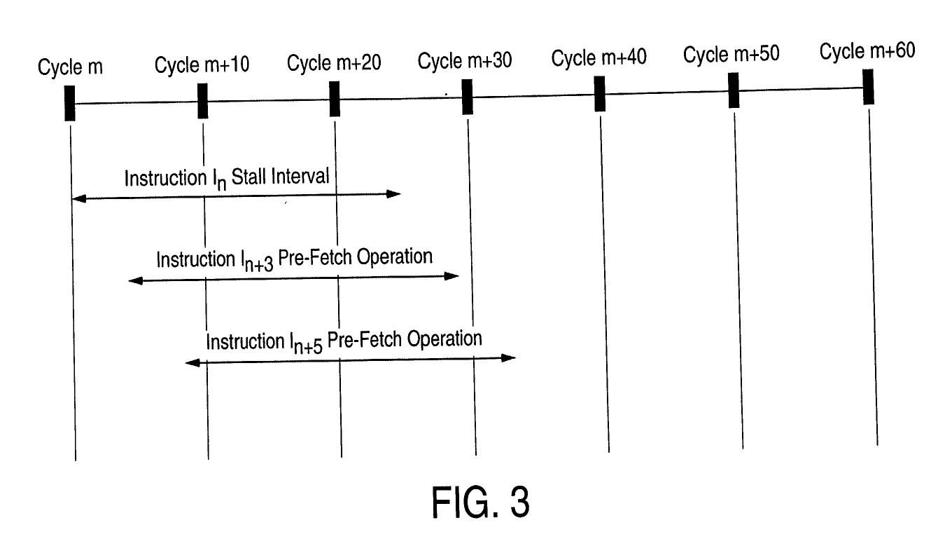

The display 38 aids users of the switching system 10 to visualize system functions/operations and user-selectable options/device parameters that are presented in a hierarchical or multi-level menu format. Each screen 50 of the display 38 represents a different menu 50 having one or more levels 48, whereby each level 48 is shown on and corresponds to a separate line 48 of the display 38. For example, as shown in FIG. 3, a display having four alphanumeric lines 48 represents a menu 50 limited to a maximum of four levels 48 per menu screen 50. Similarly, a display 38 having ten alphanumeric lines (not shown) represents a menu limited to a maximum of ten levels per menu screen. Other display configurations, though not specifically described herein, are also included within the scope of the present invention.

Each level 48 of a display menu 50 may further represent another sub-menu including one or more levels and/or sub-menus. In one embodiment of the present invention, when a level 48 of a menu 50 is selected, all related sub-levels or sub-menus corresponding to the selected level are simultaneously and visibly shown on the display screen of the device 10. Further, each of these sub-levels and/or sub-menus may also be selected, thereby presenting yet additional sub-levels or sub-menus relating to the level selected.

In another embodiment, each additional sub-level relating to a selected level of a menu 50 is visibly shown on the display 38, one sub-level at a time, by depressing a push-button 46 on the keypad 40 of the switching device 10. For example, depressing the push-button 46 of a selected level causes the first sub-level to be visibly displayed on the device 10. Depressing the same push-button 46 once more removes the first sub-level from the display 38 and causes the second sub-level to be displayed in its place. Additional sub-levels are displayed by repeating the previously described procedure.

The multi-level menu format of the present invention allows an operator of the switching system to simultaneously see all levels associated with a particular menu on the display. Further, this format also enables the operator to instantaneously skip to different levels or menus by simply depressing the corresponding push-button 46, as opposed to proceeding up or down the menu 50 one level 48 at a time as with conventional systems. In general, there are no limits to either the minimum or maximum number of menus 50 and/or sub-menus contained within the hierarchical menu system. However, the quantity or number of available display lines 48 may limit the maximum number of levels 48 or sub-menus that can be simultaneously displayed on each menu screen.

In addition to providing multiple menu levels or layers, each level 48 of a menu 50 may also be either active or inactive. An active level represents an operational menu option or function that may be selected by an operator or user of the device 10. In contrast, an inactive level represents a non-operational menu option/function that may not be selected or modified by a user of the device 10 but, rather, is mainly for information purposes. Therefore, with respect to the previous example of a four-line display 38, such a display may be limited to a maximum of four active levels for each menu 50. However, each menu 50 may also include less than four active levels, such as three active levels and one inactive level, two active levels and two inactive levels, or other similar configurations. Additional details and examples concerning display configurations and the hierarchical menu structure are further described below.

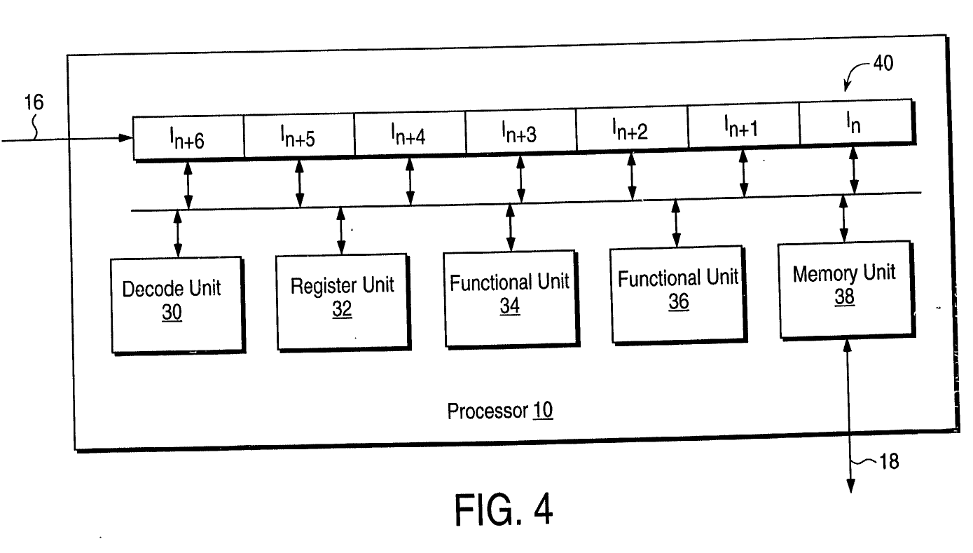

A level or sub-menu may be selected by depressing a corresponding push-button 46 located on the keypad 40 of the control panel 36. In general, each push-button 46 corresponds to one of the alphanumeric lines or levels 48 shown on the display 38 of the device 10. As previously described, the levels 48 may be either active or inactive. In one embodiment of the invention, each push-button 46 corresponding to an active level in a menu 50 shown on the display 38 is illuminated by a LED (light emitting diode) light, whereas inactive push-buttons are not illuminated. For example, as shown in FIG. 4, the first, i.e. “System,” line 48 is active as indicated by the corresponding illuminated push-button 46 (the illumination is shown as rays projecting radially outward from the push-button). The remaining, i.e. “Firmware Revisions,” “Boot: 02.05,” and “Flash: 02.15,” lines 48 are inactive and, therefore, the push-buttons 46 corresponding to those lines 48 are not illuminated.

In addition to LEDs, halogen lamps, fiber-optic devices and other lights and/or light sources not specifically disclosed herein, but well known in the art, are also included within the scope or the claimed invention. As such, the emitted light allows a user of the device 10 to quickly and easily differentiate between active and inactive levels 48 for each display menu 50.

In an alternate embodiment of the invention (not shown), one or more lights are located on the front control panel 36 adjacent each push-button 46 and/or each line/level 48 of the display 38. In yet another embodiment of the invention (not shown), active line(s) or level(s) are differentiated from inactive line(s) or level(s) via highlighting, illumination, differing text formats (e.g., font, font size, font style, etc.) or other types of visual indicators. Other devices or methods used to differentiate between active and inactive levels, though not specifically disclosed herein, are also included within the scope of the present invention.

An additional visual indicator may be provided to differentiate between active, selected lines and active, non-selected lines. In one embodiment, arrows, pointers or other similar selection markers 52 are displayed adjacent the selected line 48. For example, as shown in FIG. 5, arrows 52 are displayed adjacent the first and last character spaces 54, 56 on the second line 58 of the “Operations” menu 60. As such, the arrows 52 provide a visual indicator to a user of the device 10 to confirm that line two 58 is the line currently selected on the display menu 60. Other types of visual indicators including, but not limited to, highlighting, illumination, or differing text formats (e.g., font, font size, font style, etc.), may also be used and, thus, are also included within the scope of the present invention.

As previously disclosed, levels or sub-menus may be selected by depressing a corresponding push-button 46 located on the keypad 40 of the control panel 36. In addition, the push-buttons 46 may also be used to select additional sub-levels and/or specific device parameters 62 relating to the chosen line or level 48. In one embodiment of the present invention, lines or levels 48 containing two or more device parameters 62 are arranged so that the device parameters 62 are presented in a type of looped configuration. By repeatedly depressing a push-button 46, an operator of the switching device 10 may scroll or sequentially step through the various device parameters 62 or options associated with the selected line or level 48. A single device parameter 62 is displayed each time the push-button 46 is depressed. When the end of the device parameters list is reached, the system automatically loops back or returns to the beginning of the parameters list. Once again, the operator of the device is able to scroll or step through the various device parameters until the desired parameter is displayed and, thereby selected.

Although different menus, levels, sub-menus, sub-levels and device parameters may be accessed or selected using the push-buttons 46 alone, a rotary knob 44 may also be provided to further simplify the method of using the switching device 10 of the present invention. In general, the rotary knob 44 of the switching device 10 is similar to that of a tuning knob on a radio (not shown). Although a tuning knob is used to select a particular frequency within either a FM (frequency modulation) or AM (amplitude modulation) radio broadcast band, the rotary knob 44 of the present invention may be used, for example, to select the various device parameters 62 included within each display line or level 48. In addition to a rotary knob 44, a slider bars, thumb wheels or other similar devices known in the art are also included within the scope of the claimed invention.

In one embodiment of the present invention, an operator of the switching device 10 first selects a particular line or level 48 displayed on a menu 50 of the switching device 10 by depressing the corresponding push-button 46. Next, the operator searches through a variety of device parameters 62 relating to the selected line/level 48 by rotating the rotary knob 44 in either a clockwise or counter-clockwise direction. Each incremental turn of the rotary knob 44 causes a different device parameter 62 to be displayed on the display screen 38 of the switching device 10. To select a particular parameter 62, the operator stops rotating the rotary knob 44 when the desired parameter 62 is displayed. As previously described, the device parameters 62 are arranged in a type of loop configuration, thereby allowing a device user to repeatedly cycle or step through numerous system parameters in a simplified and efficient manner.

In another embodiment of the invention, one or more sounds are added to the switching system 10 to further aid the operator in using the device of the present invention. A variety of sounds such as chime, ding, bell, chord and other sounds not specifically disclosed herein may be used with the switching system 10. Sound emanates from the speaker 42 located on the control panel 36 when a particular operating procedure is performed. In addition to a speaker 42, a piezoelectric device or other sound generating devices are also included within the scope of the claimed invention. For example, a sound may be produced after each incremental turn of the rotary knob 44, indicating that a different device parameter 62 is presented on the display screen 50. In addition, a sound may also be produced each time a push-button 46 is depressed. Either the same sound or different sounds may be used to alert the operator that a different menu, level or parameter is presented on the display screen of the switching device 10.

### Method of Use

Many methods of using the hierarchical, menu driven system of the switching device 10 of the present invention are contemplated herein. Each methodology is related to the particular configuration of the switching system 10. The following exemplary method is intended for illustration purposes only and is not meant to limit the claimed invention.

In one embodiment, the switching system 10 includes a four-line alphanumeric display 38, four push-buttons 46, a rotary knob 44, a speaker 42 and several plug-in cards 28, such as the Model 1260-120 located in the third slot 26 at the back 16 of the chassis 12 of the device 10. The system 10 also includes a menu hierarchy of four menus 50 or general types of functions. The Operations Menu 64 is used to open and close relays on switching plug-ins and set logic levels high or low on digital I/O plug-ins. The Settings Menu 66 is used to set menu preferences such as IEEE-488 address, RS-232 baud rate, and display brightness. The Store/Recall Menu 68 is used to store switch states and menu preferences to non-volatile (flash) RAM (Random Access Memory) and recall these states and preferences. The System Menu 70 shows firmware revisions for boot memory and flash memory. This function facilitates efficient responses when contacting Customer Service.

To close relay channel two on the plug-in card 28, an operator first activates the switching system 10. Upon activation of the device, the System Menu 70, such as that shown in FIG. 6, is presented on the display 38. To display a different menu, the operator depresses the first push-button 72 on the keypad 40.

As shown in FIG. 7, depressing the first push-button 72 causes the corresponding line (i.e., line one or the first line) 74 of the display 38 to be selected. The rotary knob 44 is then incrementally rotated to the right (i.e. clockwise) to change menus. A clicking sound emanates from the control panel speaker 42 (not shown) as the knob 44 rotates. At each clicking sound, the selected display line presents another menu choice.

The menu displayed after the first click and/or incremental rotation of the knob 44 is the Store/Recall Menu 68. As shown in FIG. 8, selection of the Store/Recall Menu 68 causes the related levels displayed on lines two 76, three 78 and four 80 to also change.

An additional, incremental rotation of the knob 44 to the right causes the Settings Menu 66 to be selected/displayed. Once again, as shown in FIG. 9, selection of the Settings Menu 70 causes the related levels displayed on lines two 82, three 84 and four 86 to also change.

A final, incremental rotation of the knob 44 to the right causes the desired Operations Menu 64 to be selected/displayed, along with its corresponding levels, as shown in FIG. 10. As previously described, the Operations Menu 64 includes the functions for operating the relays.

To access the desired plug-in card, the operator depresses the second push-button 88 on the keypad 40, thereby selecting the appropriate and corresponding second display line 90. As shown in FIG. 11, line two 90 indicates that slot one contains a Model 1260-118 plug-in. To access the appropriate slot and plug-in card, the operator incrementally rotates the rotary knob 44 to the right. Referring to FIG. 12, one incremental rotation of the rotary knob causes the contents of slot two of the device 10 to be shown on line two 90 of the display 38. Another incremental rotation of the rotary knob 44 causes the contents of slot three, the desired slot, to be displayed. As shown in FIG. 13, slot three contains the Model 1260-120 plug-in card.

The operator of the switching device 10 depresses the third push-button 92 on the keypad 40 of the control panel 36 to access the appropriate relay channel. FIG. 14 illustrates the contents of the display 38 when line three 94 is selected. The method of selecting the desired channel, i.e., channel two, is similar to the previously described method of selecting a menu or slot/plug-in card. As such, the rotary knob 44 is incrementally rotated to the right until channel two is displayed, as shown in FIG. 15.

To close relay channel two, the operator of the device depresses the fourth push-button 96 on the keypad 40 to select line four 98 of the display 38 and rotates the rotary knob 44 to view the next choice for the relay status. Referring to FIG. 16, the fourth line 98 of the display 38 asks whether to close the relay channel. If the operator does not want to close the relay channel, any push-button other than the fourth key 96 may be depressed to cancel this function. However, to respond in the affirmative and confirm that the relay channel should be closed, the operator depresses the fourth push-button 96 of the keypad 40. As shown in FIG. 17, the display 38 then shows the updated relay status.

After closing the relay channel, the user has a variety of available options. For example, the device operator can re-open channel two by selecting the “open” function on line four 98 of the display 38. Alternatively, the operator may depress the third push-button 92 on the keypad 40 to select and subsequently set parameters for a different channel number. As another alternative, the operator may depress the second push-button 88 on the keypad 40 to select and subsequently work with a different slot of the switching device 10. As a final alternative, the operator may depress the first push-button 72 on the keypad 40 to thereby select and work with a completely different menu. Therefore, the user is able to perform a variety of functions and, further, can instantly skip to any level without having to proceed up or down the menu structure one level at a time.

In another embodiment of the invention, the push-buttons are used in place of the rotary knob to select a desired device parameter. For example, with respect to the Operations Menu 64, the third push-button 92 is depressed to select line three 94, i.e. relay channel, of the display 38. However, to select a desired channel number, such as relay channel three, the operator depresses the third push-button 94 of the keypad 40 three times. Alternatively, to select relay channel five, the operator depresses the third push-button 94 of the keypad 40 five times.

As previously disclosed, the device parameters, such as the various channel numbers, are arranged in a list format having a type of loop configuration. By repeatedly depressing the push-button, the operator is able to sequentially scroll or step through the list of device parameters or options associated with the selected line or menu level. The system automatically loops back or returns to the beginning of the parameters list when the end of the list is reached. Thus, for example, if the operator desires to select channel five, yet depresses the appropriate push-button six times, the operator may continue to depress the push-button until the display steps through all available relay channels and then loops back to relay channel zero. At this point, the operator depresses the push-button five additional times to select the desired fifth relay channel.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A system comprising:
a multilevel menu interface having one or more menus, each of said menus having one or more levels with selectable parameters at each level, wherein all selected parameters at each menu level are simultaneously, visibly displayed.

2. The system of claim 1 wherein said interface includes four or fewer menus.

3. The system of claim 1 wherein each of said menus include four or fewer levels.

4. The system of claim 1 wherein said menus include an Operations menu, a Settings menu, a Store/Recall menu and a System menu.

5. The system of claim 4 wherein said Operations menu includes a Slot level, a Channel level and a Status level.

6. The system of claim 4 wherein said Settings menu includes a Type level, an Option level and a Status level.

7. The system of claim 4 wherein said Store/Recall menu includes a Type level, an Option level and a Recall level.

8. The system of claim 4 wherein said System menu includes a Firmware Revisions level, a Boot level and a Flash level.

9. The system of claim 1 further comprising a display having one or more alphanumeric lines.

10. The system of claim 9 wherein each of said levels is displayed on one of said lines.

11. The system of claim 9 wherein said lines include a first line and successive lines.

12. The system of claim 11 wherein said first line displays a top level of said menu and said successive lines display successively lower levels.

13. The system of claim 9 further comprising a keypad having one or more push-buttons.

14. The system of claim 13 wherein each of said push-buttons correspond to one of said lines on said display.

15. The system of claim 14 wherein said push-buttons control selection of each level.

16. The system of claim 15 wherein said push-buttons control selection of said parameters.

17. The system of claim 13 further comprising a rotary knob that controls selection of said parameters.

18. A method of using a multi-level menu interface of a switching system comprising:
activating said system so that a first menu having one or more levels is presented on a display of said system, wherein each of said levels is presented on a line of said display;
depressing a first push-button on a keypad of said system to select a first level, said first push-button corresponding to a first line on said display;
incrementally rotating a rotary knob, wherein an incremental rotation causes a second menu to be displayed;
depressing a second push-button on said keypad to select a second level on said second menu;
incrementally rotating said rotary knob to select a parameter of said second level, wherein each incremental rotation causes a different parameter to be displayed;
depressing a third push-button on said keypad to select a third level on said second menu;
incrementally rotating said rotary knob to select a parameter of said third level;
depressing a fourth push-button on said keypad to select a fourth level on said second menu; and
incrementally rotating said rotary knob to select a parameter of said fourth level.

19. A method of using a multi-level menu interface of a switching system comprising:
activating said system so that a first menu having one or more levels is presented on a display of said system, wherein each of said levels is presented on a line of said display;
depressing a first push-button on a keypad of said system to select a first level, said first push-button corresponding to a first line on said display;
depressing said first push-button one or more times, wherein each press of said push-button causes a different menu to be displayed;
selecting a second menu;
depressing a second push-button on said keypad to select a second level on said second menu;
depressing said second push-button one or more times to select a parameter of said second level;
depressing a third push-button on said keypad to select a third level on said second menu;
depressing said third push-button one or more times to select a parameter of said third level;
depressing a fourth push-button on said keypad to select a fourth level on said second menu; and
depressing said fourth push-button one or more times to select a parameter of said fourth level.
